(19) United States
(12) Patent Application Publication
(10) Pub. No.: US 2003/0014868 A1
(43) Pub. Date: Jan. 23, 2003

(54) Two-handed cutter with rotatable handles

(75) Inventors: Michael J. Cech, Madison, WI (US); Paul Johnson, Cross Plains, WI (US)

Correspondence Address: David J. Bates, Foley & Lardner, 777 East Wisconsin Avenue, Milwaukee, WI, 53202-5367, US

(73) Assignee: Aquapore Moisture Systems

(21) Appl. No.: 10/201,513

(22) Filed: Jul. 23, 2002

Related U.S. Application Data
(60) Provisional application No. 60/307,306, filed on Jul. 23, 2001.

(51) Int. Cl. B26B 27/00; B25G 1/06

(52) U.S. Cl. 30/296.1; 30/341

(57) ABSTRACT

A two-handed cutting tool comprises a first cutting element and a second cutting element. The first cutting element includes a first handle coupled to a first blade and the second cutting element includes a second handle coupled to a second blade. The first and second cutting element are coupled together so that the first and second blades are actuable between an open position and a closed position when the handles are operated towards and away from each other in an operating plane. At least a portion of the first handles is rotatable about an axis extending in the operating plane.

### CROSS REFERENCE TO RELATED APPLICATIONS

The present application claims priority under 35 U.S.C. § 119(e) from U.S. Provisional Application Serial No. 60/307,306 entitled “Two-Handed Cutter with Rotatable Handles” and filed on Jul. 23, 2001 by Michael J. Check et al., the full disclosure of which is hereby incorporated by reference.

### FIELD OF THE INVENTION

This application relates to hedge shears, loppers and other two-handed cutters. More particularly, it relates to two-handed cutters having improved cutting efficiency and comfort.

### BACKGROUND OF THE INVENTION

In the cutting process using traditional hedge shears, the two handles are initially spread wide apart so that branches can be collected within the sector covered by the cutting blades prior to beginning the cutting stroke. As the cut proceeds, the handles are collapsed towards one another until the cut is completed or the handles bump together. During this process, the user of typical hedge shears must maintain the wrists in a fixed orientation despite the widely and constantly changing separation between the handles because the handles have a fixed orientation relative to the blades. As a result, the wrists are often forced to assume an unnatural position and leverage is decreased. Over time, this can lead to repetitive stress injuries.

The use of gear and linkage systems in hedge shears is known in the art. The purpose of these systems is to increase cutting force. However, this usually also results in increased movement of the handles, which forces the user to extend even further than would normally be the case. Hence, the wrists are more likely to be forced into awkward positions with such systems.

Accordingly, there is a need to provide a hedge shear with increased cutting force that allows the wrists to remain in a natural, comfortable position throughout the entire cutting operation.

### SUMMARY OF THE INVENTION

The present invention relates to a cutting tool. The cutting tool comprises a first cutting element and a second cutting element. The first cutting element includes a first handle coupled to a first blade and the second cutting element includes a second handle coupled to a second blade. The first and second cutting element are coupled together so that the first and second blades are actuable between an open position and a closed position when the handles are operated towards and away from each other in an operating plane. At least a portion of the first handles is rotatable about an axis extending in the operating plane.

These and other benefits and features of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

FIG. 1 is a top plan view of a preferred embodiment of a hedge shears in accordance with the present invention, the shears being shown in the open position with solid lines and in the closed position with phantom lines.

FIG. 2 is a schematic representation of the left and right handles of the shears of FIG. 1, the handles being shown in the open position with solid lines and in the closed position with phantom lines.

FIG. 3 is an exploded, perspective view of the shears of FIG. 1.

FIG. 4 is a cross sectional view of the shears of FIG. 1 seen approximately from the plane indicated by line 4-4 on FIG. 6;

FIG. 5 is a cross sectional view of the shears of FIG. 1 taken along line 5-5 in FIG. 4.

FIG. 6 a cross sectional view of the shears of FIG. 1 taken along line 5-5 in FIG. 4.

FIG. 7 an enlarged view of the shears of FIG. 1 showing the blade-to-handle gear linkages adjacent the pivot point of the blades.

FIG. 8 a cross sectional view of the shears of FIG. 1 taken along line 8-8 in FIG. 7.

Before explaining at least one preferred embodiment of the invention in detail it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE PREFERRED EMBODIMENTS

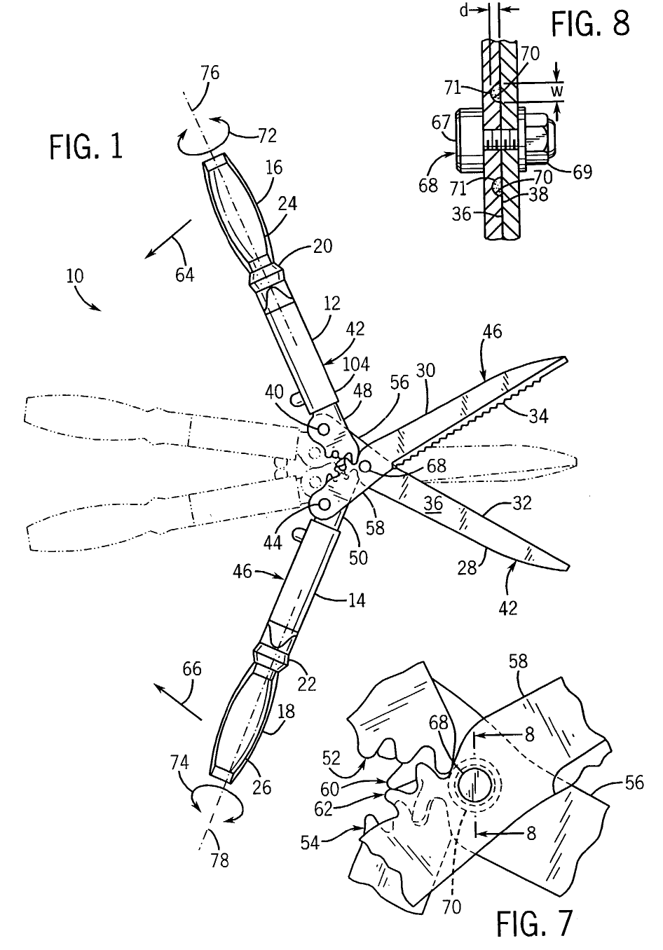

Referring to FIG. 1, a cutting tool in the form of a hedge shear 10 is shown in accordance with the present invention. Hedge shear 10 includes handles 12 and 14 which are generally straight, elongated members. Handles 12 and 14 may be formed from steel, plastic, aluminum, or any other suitable material as is well known in the art. Handles 12 and 14 include respective grips 16 and 18. Grips 16 and 18 may be formed from the same material as handles 12 and 14 or a different material. As shown in FIG. 4, grips 16 and 18 may include cores 20 and 22, respectively, which are partially or completely covered by elastomeric pads 24 and 26, respectively, to provide a use or hedge shear 10 with a more secure and comfortable grip. Elastomeric pads 24 and 26 may comprise a gel-like material such as flexible PVC or another high durometer polymer. Elastomeric pads 24 and 26 may be formed by molding the gel-like material directly onto respective cores 20 and 22 or, alternatively, by securing thin strips or sheets of the gel-like material onto cores 20 and 22 with an adhesive or some other attachment means known to persons skilled in the art. In another alternative embodiment, pads 24 and 26 could be made from the same material as cores 20 and 22 and integrally formed therewith. Grips 16 and 18 may also include raised ribs or dots on their outer surfaces to further enhance the user's grip on the hedge shear 10.

Referring again to FIG. 1, hedge shear 10 is shown with a pair of cutting blades 28 and 30. Each blade 28 and 30 includes an associated cutting edge 32 and 34 and an associated inner face 36 and 38. Cutting edges 32 and 34 are the two opposed edges of blades 28 and 30 that are closest to each other when blades 28 and 30 are in an open position (shown in solid lines in FIG. 1). Inner faces 36 and 38 are the two opposed faces of blades 28 and 30 that are closest to each other when blades 28 and 30 are in a closed position (shown in phantom lines in FIG. 1). Cutting edge 34 of blade 30 may be serrated as shown. In this embodiment, inner face 38 of blade 30 is preferably beveled along the entire length of serrated cutting edge 34 as shown and described in commonly owned U.S. Pat. No. 5,267,400, the entire contents of which are hereby incorporated by reference herein. This is to provide blade 30 with a beveled contact surface that is wide enough so that no contact occurs between cutting edge 32 and serrated cutting edge 34 when blades 28 and 30 are actuated to the closed position. Instead, cutting edge 32 of blade 28 makes its initial contact with serrated blade 30 on the beveled contact surface of inner face 38 along a line positioned inwardly of and below serrated cutting edge 34. Blades 28 and 30 are preferably formed from steel or aluminum, but they may also be formed from other materials as are well known in the art.

Still referring to FIG. 1, handle 12 is pivotally coupled to blade 28 by a fastener 40 to form a first cutting element 42. Similarly, handle 14 is pivotally coupled to blade 30 by a fastener 44 to form a second cutting element 46. In this embodiment, fasteners 40 and 44 may comprise a pivot pin with a nut. Alternatively, one or both of the handles could be non-rotatably coupled to the associated blade(s), in which case the fasteners could comprise bolts, adhesive, or simple interference fit. As another alternative where one or both of the handles is non-rotatably coupled to the associated blade(s), the coupling(s) therebetween could be provided by injection molding the handle(s) directly around the tang(s) of the blade(s). Persons skilled in the art will recognize that numerous other coupling techniques could be used.

In a preferred form of the invention, handles 12 and 14 include blade tangs 48 and 50, respectively, which terminate at their distal ends with gear elements 52 and 54, respectively (see FIG. 7). In addition, blades 28 and 30 include shank portions 56 and 58, respectively, which include gear elements 60 and 62, respectively. As best illustrated in FIG. 7, gear 52 on tang 48 of handle 12 is configured to mesh with gear 62 on shank 58 of blade 30. Similarly, gear 54 on tang 50 of handle 14 is configured to mesh with gear 60 on shank 56 of blade 28. In a particularly preferred embodiment illustrated in FIG. 1, handle gears 52 and 54 include teeth which increase in length toward the outside of hedge shears 10, and blade gears 60 and 62 have an opposite geometry. This structure provides the use of shears 10 with an increased cutting force as handles 12 and 14 approach each other. Further details of these handle-to-blade gear linkages and their associated advantages is provided in commonly owned U.S. patent application Ser. No. 09/849,760, filed May 4, 2001, the entire contents of which are hereby incorporated by reference herein.

As shown in FIG. 1, handles 12 and 14 are operable towards and away from each other (as indicated by arrows 64 and 66) in an operating plane. As handles 12 and 14 are actuated, handle gears 52 and 54 and blade gears 60 and 62 engage each other as described above to actuate blades 28 and 30 about a pivot point 68. Pivot point 68 may comprise a typical straight shaft pivot pin 67 (see FIG. 8) secured by a nut 69 or any other type of fastener that allows blades 28 and 30 to rotate about a fixed point. Additionally, pivot point 68 may be coated with grease or another lubricant to reduce the friction involved in opening and closing hedge shears 10. In a preferred embodiment illustrated in FIGS. 7 and 8, shank portion 58 of blade 30 includes an annular recess 70 formed on inner face 38, which recess 70 preferably extends all the way around pivot point 68. By way of example and not limitation, annular recess 70 may have a width “w” of about ⅛th inch and a depth “d” of about 1/16th inch (see FIG. 8). In assembly, recess 70 is completely closed by inner face 36 of blade 28. Thus, recess 70 can be packed with and retain grease 71 or a similar lubricant to ensure smooth operation of shears 10 over numerous openings and closings thereof and thus further reduces wear around pivot point 68.

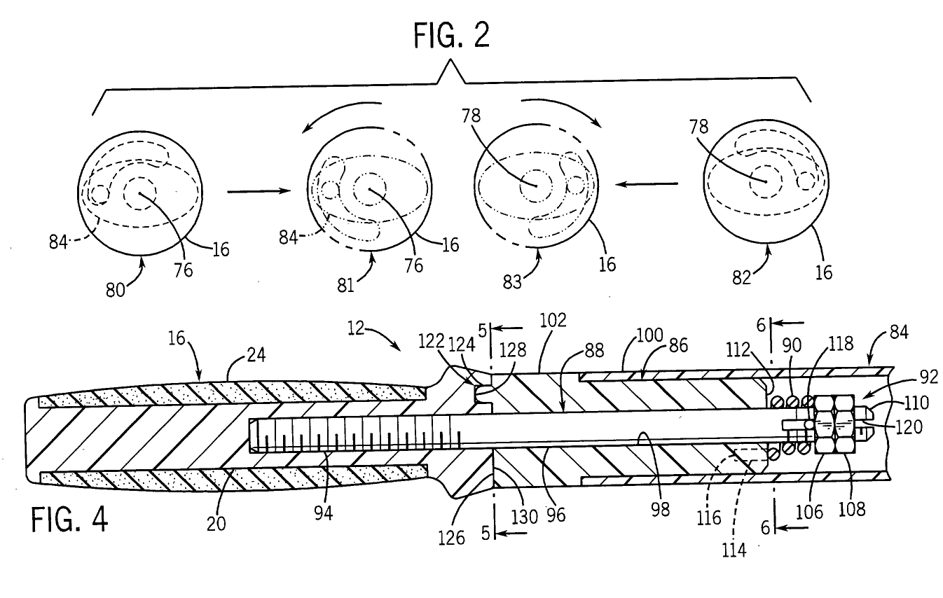

As shown in FIGS. 1, hand grips 16 and 18 are mounted for rotation (as indicated by arrows 72 and 74) about axes 76 and 78, respectively, which extend centrally through handles 12 and 14, respectively. The specific directions of rotations of hand grips 16 and 18 during opening and closing of shears 10 is best seen in FIG. 2. In FIG. 2, the leftmost and rightmost images 80 and 82 are schematic representations of handles 14 and 16, respectively, when viewed along handle axes 76 and 78 with grips 16 and 18 in the foreground when shears 10 is in the open position (shown in solid lines in FIGS. 1 and 2). In FIG. 2, the left and right innermost images 81 and 83 are schematic representations of handles 12 and 14 after they have been brought all the way towards one another (as indicated by arrows 64 and 66) so that shears 10 is in the closed position (shown in phantom lines in FIGS. 1 and 2). In this position, grips 16 and 18 will have rotated in opposite directions (as indicated by arrows 72 and 74) in accordance with the natural movements of the user's wrists. In particular, the user's left hand (and thus grip 16) will naturally tend to rotate counterclockwise (see arrow 72) upon closing movement of shears 10, while the user's right hand (and thus grip 18) will naturally tend to rotate clockwise (see arrow 74) upon closing movement of shears 10. When the grips 16 and 18 are again moved away from each other to actuate blades 28 and 30 to the open position, the user's wrists (and thus grips 16 and 18) will naturally tend to rotate in the opposite directions until they return to their starting positions.

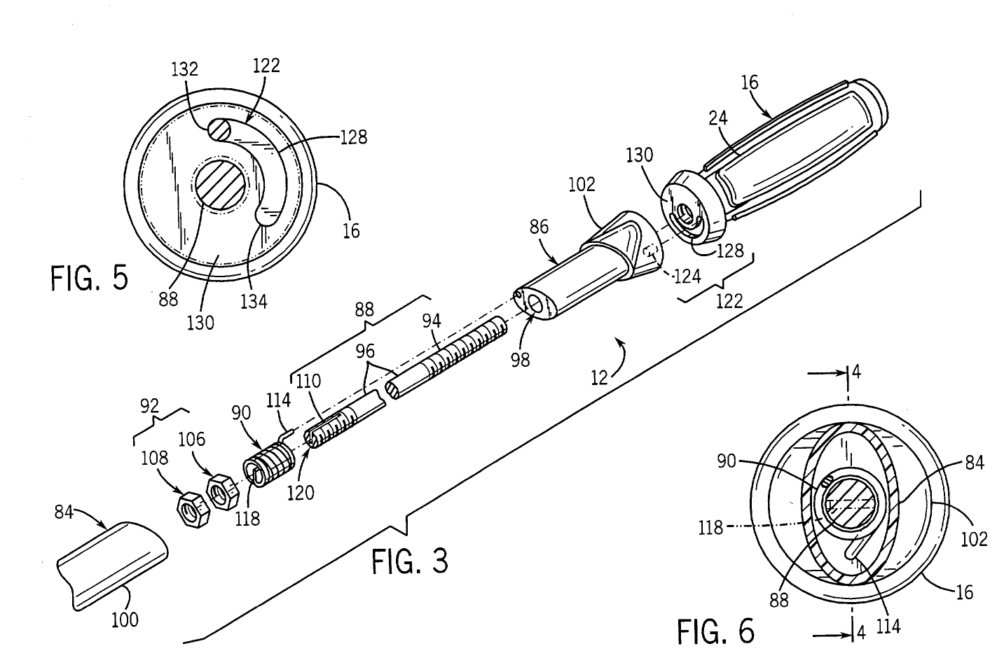

Referring now to FIGS. 4-6, a preferred structure for rotatably mounting grips 16 and 18 on respective handles 12 and 14 will be described and illustrated with reference only to handle 12 because the other handle (i.e., handle 14) is substantially identical. As best seen in FIG. 3, the main elements used for rotatably mounting grip 16 on handle 12 comprise a tubular sleeve 84, a handle insert 86, a double-threaded rod 88, a spring 90 and a retainer 92. In assembly, a proximal threaded end 94 of rod 88 is threadedly (i.e., non-rotatably) engaged in core 20 of grip 16 (see FIG. 4). In addition, a middle (unthreaded) portion 96 of rod 88 is supported for rotation in a central bore 98 of handle insert 86, which in turn is non-rotatably secured within a proximal end portion 100 of tubular sleeve 84. Handle insert 86 is illustrated with a flared end 102 that provides a smooth transition between an elliptical cross-sectional shape (see FIG. 6) of tubular sleeve 84 and a circular cross-sectional shape of grip 16. Tubular sleeve 84 includes a distal portion 104 (see FIG. 1) which is non-rotatably secured over blade tang 48 by suitable means. For example, tubular sleeve 84 may be molded directly over the proximal end of blade tang 48. Alternatively, tubular sleeve 84 could be separately manufactured and then secured to blade tang 48 by subsequent assembly. As another alternative, tubular sleeve 84 and blade tang 48 could be integrally formed from the same material in a single operation.

As best seen in FIG. 4, rod 88 is maintained in axial position in central bore 98 of handle insert 86 by retainer 92, which thus prevents grip 16 from being inadvertently removed during operation of shears 10. As illustrated, retainer 92 may be a pair of nuts 106 and 108 threadedly engaged on a distal threaded end 110 of rod 88. Nuts 106 and 108 also function to maintain spring 90 in its position between a distal face 112 of handle insert 86 and nut 106. Spring 90 has a proximal end 114 secured in a bore 116 formed in distal face 112 and a distal end 118 secured in an axially extending slot 120 formed in distal threaded end 110 of rod 88. Thus, spring 90 elastically couples the rotatably mounted rod 88 to the non-rotatably mounted handle insert 86. As such, when grip 16 is rotated counterclockwise (see arrow 72 in FIG. 2) during closing movement of shears 10, a torsional load will be imparted by rod 88 into spring 90 and stored therein. During opening movement of shears 10, spring 90 will release its torsional load by causing rod 88 and thus grip 16 to automatically return to their starting positions.

In a preferred embodiment, grip 16 is limited in rotation by a stop structure 122 located at the interface between handle insert 86 and grip 16. As best seen in FIGS. 4 and 5 (taken together), stop structure 122 may comprise a projection 124 formed on a proximal face 126 of handle insert 86 which extends into and slides along a curved groove 128 formed on a distal face 130 of grip 16. During operation of shears 10, projection 124 abuts against a first end 132 of groove 128 to limit (or stop) the counterclockwise rotation of grip 16. Similarly, projection 124 also abuts against a second end 134 of groove 128 to limit (or stop) the clockwise rotation of grip 16. Persons skilled in the art will understand that the length of groove 128 may be adjusted to provide any desired range of rotation between grip 16 and the remainder of handle 12. However, it has been found that between about 45 degrees and 180 degrees of rotation is preferably, with about 90 degrees of rotation being presently most preferred.

It is important to note that the above-described preferred embodiments of the hedge shears are illustrative only. Although the invention has been described in conjunction with specific embodiments thereof, those skilled in the art will appreciate that numerous modifications are possible without materially departing from the novel teachings and advantages of the subject matter described herein. For example, although the stop structure is illustrated with projection 124 on handle insert 86 and groove 128 on grip 16, the locations of these stop elements could be reversed. In addition, although only the grip portions 16 and 18 of handles 12 and 14 were illustrated as being rotatable about handle axes 76 and 78, respectively, a larger portion (or even the entirely) of handles 12 and 14 could be rotatable about the handle axes. Accordingly, these and all other such modifications are intended to be included within the scope of the present invention. Other substitutions, modifications, changes and omissions may be made in the design, operating conditions and arrangement of the preferred and other exemplary embodiments without departing from the spirit of the present invention.

What is claimed is:

1. A two-handed cutting tool, comprising:
a first cutting element having a first handle coupled to a first blade;
a second cutting element having a second handle coupled to a second blade;
the first and second cutting elements being coupled together so that the first and second blades are actuable between an open position and a closed position when the first and second handles are operated towards and away from each other in an operating plane,
wherein at least a portion of the first handle is mounted for rotation about a first axis extending in the operating plane.

2. The cutting tool of claim 1, wherein at least a portion of the second handle is mounted for rotation about a second axis extending in the operating plane.

3. The cutting tool of claim 2, wherein each handle is elongated along the associated axis.

4. The cutting tool of claim 2, wherein each handle includes a grip portion positioned opposite the associated blade, the grip portion being rotatable about the associated axis.

5. The cutting tool of claim 4, wherein each handle includes an outer sleeve positioned intermediate the associated grip portion and blade, the outer sleeve being non-rotatable about the associated axis.

6. The cutting tool of claim 4, wherein each grip portion is non-rotatably attached to an end of a rod extending through the handle along the associated axis, the rod being rotatably mounted in the handle.

7. The cutting tool of claim 6, wherein each rod is rotatably supported in the handle by a handle insert, the handle insert being non-rotatably secured in an outer sleeve extending between the associated blade and grip portion.

8. The cutting tool of claim 7, wherein each rod is coupled to the associated handle insert by a spring which biases the grip portion in a clockwise or counterclockwise direction of rotation.

9. The cutting tool of claim 7, wherein one of the grip portion and the handle insert includes a projection configured to extend into a curved slot formed in the other of the grip portion and the handle insert, the projection and the groove providing a pair of stops for limiting the rotation of the grip portion.

10. The cutting tool of claim 2, wherein the rotatably mounted portion of each handle is,biased in a clockwise or counterclockwise direction of rotation against a first stop.

11. The cutting tool of claim 10, wherein the rotatably mounted portions of the first and second handles are biased in opposite directions of rotation.

12. The cutting tool of claim 10, wherein each handle includes a second stop which restricts the range of rotation of the rotatably mounted portion to between about 90 to 180 degrees.

13. The cutting tool of claim 2, wherein the rotatably mounted portion of each handle includes a hand grip.

14. The cutting tool of claim 13, wherein each grip includes a gel-filled pad.

15. The cutting tool of claim 13, wherein the gel-filled pad is a palm pad.

16. The cutting tool of claim 2, wherein the tool has a geared linkage for increased cutting power.

17. The cutting tool of claim 16, wherein the tool is a shears having a compound cutting action.

18. The cutting tool of claim 2, wherein each blade has an inner face in sliding contact with the inner face of the other blade in a pivot region surrounding a blade pivot point, the inner face of one of the blades having a recess for receiving a lubricant.

19. The cutting tool of claim 18, wherein the cavity is an annular recess extending around the blade pivot point.

20. The cutting tool of claim 18, wherein each handle is coupled to the associated blade by a handle pivot point located proximally of the blade pivot point.

21. The cutting tool of claim 20, wherein each handle pivot point includes a geared linkage between the blade and the handle.

22. The cutting tool of claim 2, wherein each cutting element includes a bumper for restricting closure of the handles.

23. The cutting tool of claim 2, wherein one of the blades has a serrated cutting edge.

24. The cutting tool of claim 22, wherein each of the blades has an inner face that is closest to the inner face of the other blade when the blades are in the closed position, the inner face of the serrated blade being beveled proximate the serrated cutting edge to provide a beveled contact surface, the beveled contact surface having a width sufficient that a cutting edge of the other blade makes an initial contact with the beveled contact surface rather than the serrated cutting edge upon closing of the blades.
